(19) United States
(12) Patent Application Publication
(10) Pub. No.: US 2008/0290038 A1
(43) Pub. Date: Nov. 27, 2008

(54) Magnetic hydrocarbon treatment device and method

(76) Inventors: Gordon Thomas Kaitting, Oakville (CA); George William Prior, Georgetown (CA); Robert Charles Harrison, Mississauga (CA)

Correspondence Address: Jim Helfrich, 200 Choteau St, Sun River, MT, 59483, US

(21) Appl. No.: 11/807,043

(22) Filed: May 26, 2007

(51) Int. Cl. B01D 35/06

(52) U.S. Cl. 210/695; 210/222

(57) ABSTRACT

A magnetic treatment of hydrocarbon fuel flowing through a fuel conduit. A plurality of magnets with repelling polarity is used in affecting the fuel structure and alternating said structure by aligning the hydrocarbons in a parallel uniform manner to increase combustion efficiency thus increasing power while reducing pollutants and exhaust emissions.

### RELATED APPLICATIONS

The present application is related to U.S. Pat. No. 4,568,901, issued Feb. 4, 1986, included by reference herein.

The present application is related to U.S. Pat. No. 4,808,306, issued Feb. 28, 1989, included by reference herein.

The present application is a continuation-in-part application of United States provisional patent application, Ser. No. 5129382, filed Jul. 14, 1992, included by reference herein and for which benefit of the priority date is hereby claimed.

The present application is related to U.S. Pat. No. 5,637,226, issued Jun. 10, 1997, included by reference herein.

The present application is related to U.S. Pat. No. 5,943,998, issued Aug. 31, 1999, included by reference herein.

The present application is related to U.S. Pat. No. 6,971,409, issued Dec. 6, 2005, included by reference herein.

The present application is related to U.S. Pat. No. 4,572,145, issued Feb. 25, 1984, included by reference herein.

The present application is related to U.S. Pat. No. 5,124,045, issued Jun. 23, 1992, included by reference herein.

The present application is related to U.S. Pat. No. 5,359,979, issued Nov. 1, 1994, included by reference herein.

The present application is related to U.S. Pat. No. 5,816,227, issued Oct. 6, 1998, included by reference herein.

The present application is related to U.S. Pat. No. 6,890,432, issued May 10, 2005, included by reference herein.

The present application is a continuation-in-part application of United States provisional patent application, Ser. No. 7,004,153, filed Feb. 28, 2006, included by reference herein and for which benefit of the priority date is hereby claimed.

### FIELD OF THE INVENTION

The present invention relates to fuel treatment and enhancement devices and, more particularly, to magnetic hydrocarbon treatment devices and methods.

### BACKGROUND OF THE INVENTION

Hydro carbon fuels lack stability and the variability of the stability of these hydrocarbon fuels fluctuates due to storage conditions, refining methods, transportation methods, as well as environmental conditions resulting in a clustering of molecules. As the clustering of molecules increases the burn ability of the fuels decreases. Fuel efficiency drops, maintenance issues increase and an over all lack of efficiency besets the systems using these fuels as their energy source. Some of this activity is compounded through introduced bio-organisms such as bacteria, molds, fungus and other microbial activity. But much of it is the result of a polymerization and agglomerations of the organic compounds in the hydro carbon fuels. The problem has been on how to prevent and or correct these issues and stabilize the fuels until they can be burned.

Early users of these and similar fuels were not faced with the issues of today such as very high cost and shortage of resource coupled with environmental issues concerning the emission of dangerous and harmful toxins and chemicals into the atmosphere. People were both unconcerned and unaware of the health consequences that were caused by these emissions and until recently they were unaware of the additional maintenance costs resulting from the pollution of other electronic systems and even the cleaning of buildings from the discoloration effect that these emissions caused. There are both primary and secondary negative circumstances caused by the volume of emissions created by the burning of hydrocarbon fuels.

Today's economy and environmental concerns and costs do not permit operation of hydrocarbon systems as they have in the past.

A great many methods have been tried to reduce the problems previously mentioned. They include magnetic devices of varying configurations, filters of all types, flue scrubbers that clean or collect exhaust emissions or at least part of the particulates that otherwise would be sent into the atmosphere causing pollution of various sorts. Other solutions include fuel additives, blending of various combinations of fuels and additives temperature treatments and other more novel methods.

The search for solutions is ongoing and properly so since no one perfect solution has yet been found. Improvement in this area is ongoing in the attempt to find ever better ways to improve fuel efficiency while reducing combustion emissions and their hazards.

Other systems such as flue scrubbers are very expensive to install and maintain and yet again there is the issue of the particulates they have collected and how to deal with their disposal. This creates a condition where costs rise and pollution issues have been deferred rather than reduced.

Some of the others such as catalytic converters eliminate the problems of pollution and reduce fuel costs but their installation is expensive and limited in scope. They are not suitable for most after market or retro fit situations so do not address the billions of tons of fuels currently being consumed in devices that are not fitted with them. More over none of these mechanical devices actually treats the fuel before it is burned to increase the fuels efficiency and reduce its emissions.

In conclusion these present devices do not make the treatment of hydrocarbon fuels economic, convenient or efficient and there fore are used primarily only where emission reduction is mandated by law rather than employed because of the economic advantages that a new device would impart.

It is therefore an object of the invention to increase fuel efficiency.

It is another object of the invention to decrease combustion emissions.

It is another object of the invention to reduce maintenance costs.

It is another object of the invention to reduce combustion chamber size.

It is another object of the invention to fuel storage size.

It is another object of the invention to increase burn temperatures.

It is another object of the invention to reduce burn times.

### SUMMARY OF THE INVENTION

In accordance with the present invention, there is provided a magnetic treatment of hydrocarbon fuel flowing through a fuel conduit. A plurality of magnets with repelling polarity is used in affecting the fuel structure and alternating said structure by aligning the hydrocarbons in a parallel uniform manner to increase combustion efficiency thus increasing power while reducing pollutants and exhaust emissions.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a fuel line fitted with ceramic magnets arranged to affect the structure of the carbon and hydrogen molecules flowing through the fuel line;

FIG. 2 is a perspective view of a fuel line detailing the change in the hydrogen and carbon molecules after being effected by the ceramic magnets;

FIG. 3 is a perspective view of a combustion furnace retrofitted with a magnetic hydrocarbon treatment device; and

FIG. 4 is a perspective view of an oil derrick retrofitted with a magnetic hydrocarbon treatment device.

For purposes of clarity and brevity, like elements and components will bear the same designations and numbering throughout the Figures.

### DESCRIPTION OF THE PREFERRED EMBODIMENT

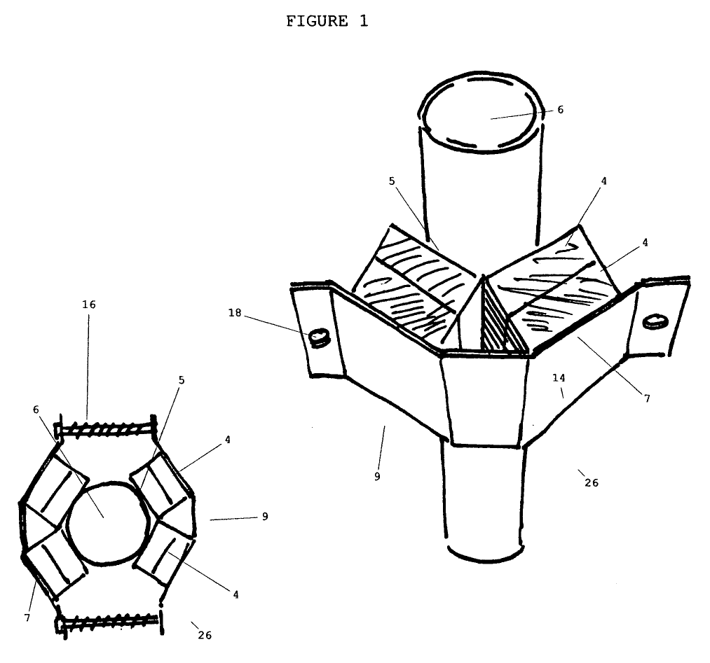

Referring now to FIG. 1, in accordance with a preferred embodiment of the present invention generally concerns a fuel treatment system wherein the system preferably comprises a ceramic magnet 4 mounted with its south polarity 5 directly against a fuel conduit 6 with a plurality of additional ceramic magnet 4 (s) fitted circularly around the same fuel conduit 6 with all conduit contact sides providing a south polarity 5 ensuring an opposing force on all sides of the fuel conduit 6. The generally rectangular prismatic shaped ceramic magnet 4 is made of a strontium carbonate and iron oxide and sized to fit the variables of the fuel conduits dimensions. A permanently attached metal backing 14 in contact with the north polarity 7 of the magnets provides shape for placement as well as rigidity and fastenability of the opposing magnetic sections 9. Sections are fastened by means of a standard hardware fastener 16 such as a threaded bolt passing though a formed flange at the end of each rectangular shaped metal backing 14 fitted with a fastener hole 18 in each flange opposed to a fastener hole 18 in a opposing flange.

In operation more than one set of magnets may be stacked upon the other resulting in a stronger magnetic affect upon the fuel conduit 6. The present invention may also be applied linear to have effect over a great length of the fuel conduit 6.

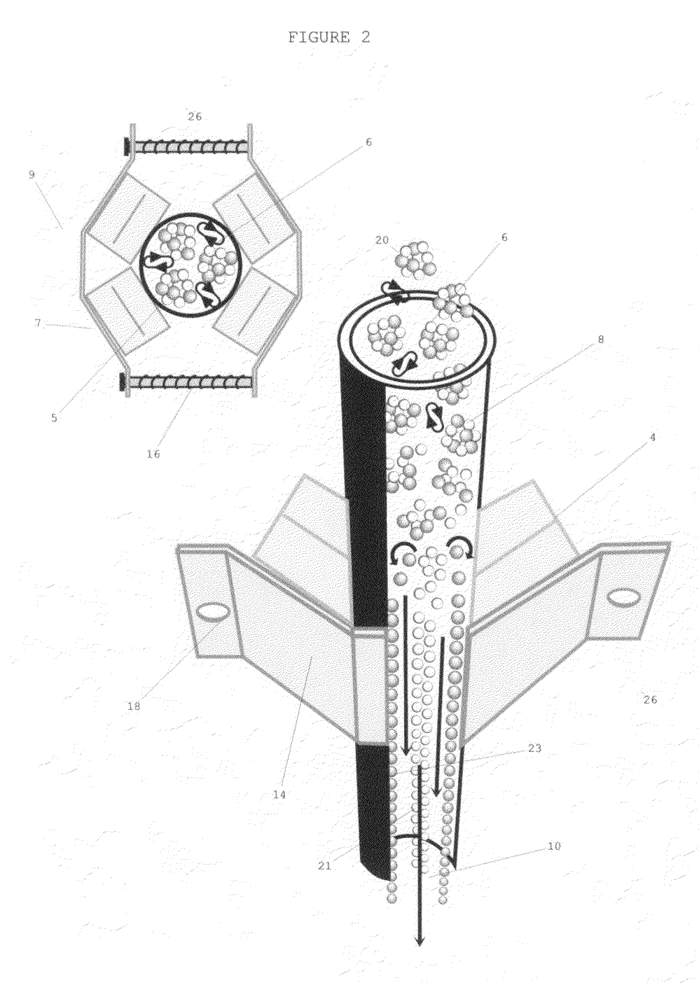

Referring now to FIG. 2, in accordance with a preferred embodiment of the present invention it shall be understood that the carbon atoms 23 and hydrogen atoms 21 move through the fuel conduit 6 from the fuel source side 8 as clusters 20 past the mounted present invention where by the negative polarity causes the hydrogen atoms 21 and carbon atoms 23 to separate and align with like atoms. In a most preferred embodiment of the present invention ceramic magnet 4 mounted with its south polarity 5 directly against a fuel conduit 6 with a plurality of additional ceramic magnet 4 (s) fitted circularly around the same fuel conduit 6 with all conduit contact sides providing a south polarity 5 ensuring an opposing force on all sides of the fuel conduit 6 causing the positively charged carbon atoms 23 to travel to the outside of the fuel conduit 6 while the negatively charged hydrogen atoms 21 are pushed to the center allowing providing for separated atoms 22 for easier combining of introduced oxygen 30 with the hydrogen atoms 21 for more complete combustion as the fuel passes the magnetic hydrocarbon treatment device 26 and moves toward the fuel outlet direction 10.

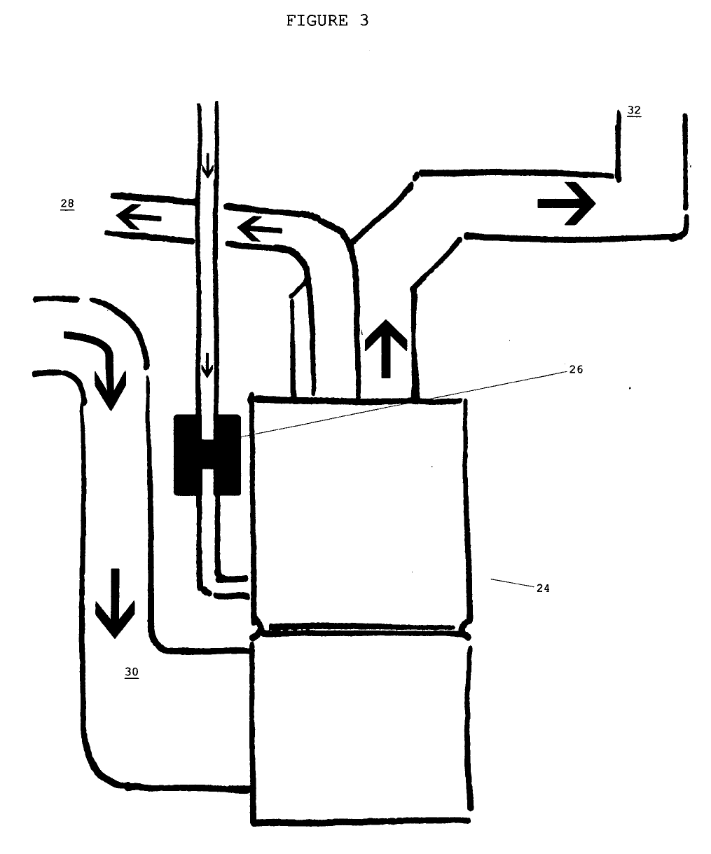

Referring now to FIG. 3, in accordance with a preferred embodiment of the present invention the magnetic hydrocarbon treatment device 26 is mounted immediately upstream from the combustion unit on the fuel conduit 6 affecting the temperature and pollutants in the flue exhaust 28.

In operation the effects of the present invention result in more complete combustion so increase the flue temperature while reducing the particulate matter emitted from the furnace 24. In the case of a furnace 24 depicted the output heat 32 temperature is increase by some 10 to 20% resulting in greater fuel efficiency while at the same time reducing the amount of unburned fuels and thus reducing the amount of expelled pollutants into the atmosphere. The effect varies depending upon the device the units are attached too. For example, in a boiler the temperature may not increase because the rate of fuel consumption will be adjusted down thus saving fuel while maintaining the appropriate temperature. In others the temperature may rise so the burn time is shortened where thermostats determine burn and rest times for a device. In yet other situations the only effect may be to reduce the expelled pollutants by providing for a more efficient burn while temperature or burn time is not an issue such as in a well burn off and in yet another instance the present invention may be applied to a pipeline designed to transport raw fuel such as crude oil as a means to increase the flow rate of the crude oil with no imminent intention to combust.

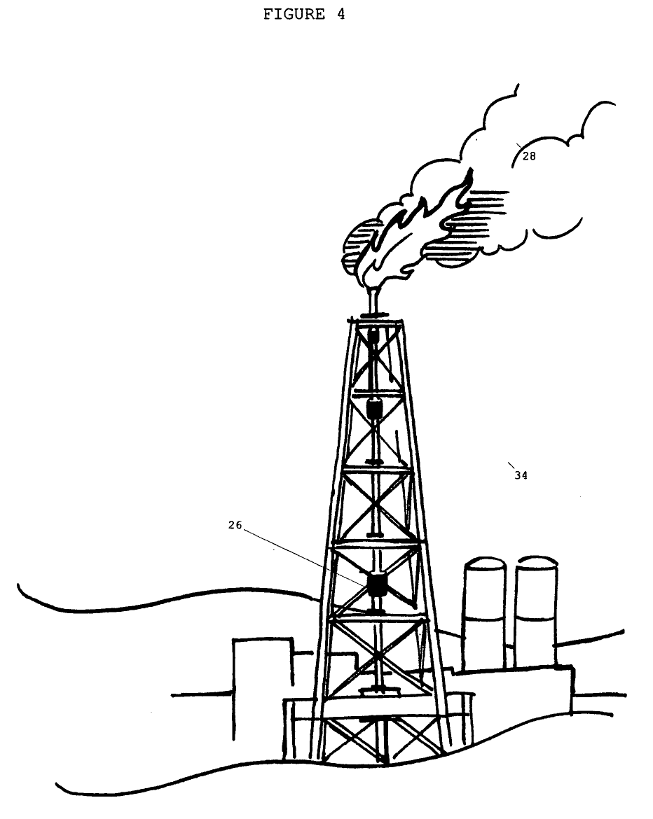

Referring now to FIG. 4, in accordance with a preferred embodiment of the present invention the magnetic hydrocarbon treatment device 26 is mounted immediately upstream from the combustion unit on the fuel conduit 6 of an oil derrick 34 with burnt gases 36 being expelled.

In operation the present invention serves to reduce pollutants being expelled into the atmosphere with no regard to burn time or specific temperature output.

It should be understood that the descriptions refer to the most preferred embodiment and it should be recognized that many minor changes in shape and mounting may be used to achieve the same results as described and that this description is not meant to limit the variability but rather to provide a reasonable understanding of the invention, its application and methods.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A magnetic hydrocarbon treatment device and method for magnetic treatment of hydrocarbon fuel flowing through a fuel conduit for greater fuel efficiency and reduced emissions, comprising:
means for pulling the positive charged carbon atoms to the outside of the pipe while pushing the negatively charged hydrogen atoms to the center;
means for permitting the application of the magnets in a uniform and consistent manner to the fuel conduit;
means for correctly positioning and maintaining the magnets in their proper relationship to the fuel line;
means for greater fuel efficiency and reduction of harmful pollutants;
means for separating the carbon and hydrogen elements for greater fuel efficiency and lower pollution; and
means for the reduction of the emissions of the flu gases eliminating many of the pollutants emitted into the atmosphere.

2. The magnetic hydrocarbon treatment device and method in accordance with claim 1, wherein said means for pulling the positive charged carbon atoms to the outside of the pipe while pushing the negatively charged hydrogen atoms to the center comprises a high intrinsic coercive force, ferrite, low temperature service, grade 5 through 8 ceramic magnet.

3. The magnetic hydrocarbon treatment device and method in accordance with claim 1, wherein said means for permitting the application of the magnets in a uniform and consistent manner to the fuel conduit comprises a cluster of magnets, rigid magnetic sections.

4. The magnetic hydrocarbon treatment device and method in accordance with claim 1, wherein said means for correctly positioning and maintaining the magnets in their proper relationship to the fuel line comprises a rigid metal backing.

5. The magnetic hydrocarbon treatment device and method in accordance with claim 1, wherein said means for greater fuel efficiency and reduction of harmful pollutants comprises a sorted to type separated atoms.

6. The magnetic hydrocarbon treatment device and method in accordance with claim 1, wherein said means for separating the carbon and hydrogen elements for greater fuel efficiency and lower pollution comprises a magnetized elements of carbon and hydrogen magnetic hydrocarbon treatment device.

7. The magnetic hydrocarbon treatment device and method in accordance with claim 1, wherein said means for the reduction of the emissions of the flu gases eliminating many of the pollutants emitted into the atmosphere comprises an un combusted fuels, pollutants flue exhaust.

8. A magnetic hydrocarbon treatment device and method for magnetic treatment of hydrocarbon fuel flowing through a fuel conduit for greater fuel efficiency and reduced emissions, comprising:
a high intrinsic coercive force, ferrite, low temperature service, grade 5 through 8 ceramic magnet, for pulling the positive charged carbon atoms to the outside of the pipe while pushing the negatively charged hydrogen atoms to the center;
a cluster of magnets, rigid magnetic sections, for permitting the application of the magnets in a uniform and consistent manner to the fuel conduit;
a rigid metal backing, for correctly positioning and maintaining the magnets in their proper relationship to the fuel line;
a sorted to type separated atoms, for greater fuel efficiency and reduction of harmful pollutants;
a magnetized elements of carbon and hydrogen magnetic hydrocarbon treatment device, for separating the carbon and hydrogen elements for greater fuel efficiency and lower pollution; and
an un combusted fuels, pollutants flue exhaust, for the reduction of the emissions of the flu gases eliminating many of the pollutants emitted into the atmosphere.

9. A magnetic hydrocarbon treatment device and method for magnetic treatment of hydrocarbon fuel flowing through a fuel conduit for greater fuel efficiency and reduced emissions, comprising:
a high intrinsic coercive force, ferrite, low temperature service, grade 5 through 8 ceramic magnet, for pulling the positive charged carbon atoms to the outside of the pipe while pushing the negatively charged hydrogen atoms to the center;
a cluster of magnets, rigid magnetic sections, for permitting the application of the magnets in a uniform and consistent manner to the fuel conduit;
a rigid metal backing, for correctly positioning and maintaining the magnets in their proper relationship to the fuel line;
a sorted to type separated atoms, for greater fuel efficiency and reduction of harmful pollutants;
a magnetized elements of carbon and hydrogen magnetic hydrocarbon treatment device, for separating the carbon and hydrogen elements for greater fuel efficiency and lower pollution; and
an un combusted fuels, pollutants flue exhaust, for the reduction of the emissions of the flu gases eliminating many of the pollutants emitted into the atmosphere.
